(19) United States
(12) Patent Application Publication
(10) Pub. No.: US 2007/0196194 A1
(43) Pub. Date: Aug. 23, 2007

(54) Pixie deck stow and go, relates to flooring that anyone can assemble

(76) Inventor: Theresa Maureen Clement, Stewartsville, NJ (US)

Correspondence Address: Theresa M. Clement, 209 Aldin Road, Stewartsville, NJ, 08886, US

(21) Appl. No.: 11/358,426

(22) Filed: Feb. 21, 2006

(51) Int. Cl. B60P 1/64

(52) U.S. Cl. 410/52

(57) ABSTRACT

The Pixie Deck is a self contained deck that folds away for storage. This is a deck that you will be able to assemble without tools. You will be able to make this decking as large as you need it, by attaching additional decks shown in FIG. 4. In FIG. 6 you will see an example of how you can attach four smaller decks (not limited) to make one larger deck. Using different size decks you will be able to design your own pattern. The Pixie Deck will fold and store away easily, shown in FIG. 9. After it has been folded, this deck is portable, by way of wheels that are built in FIG. 11. or when not feasible to roll such as gravel or sand you will use a built in skid shown in FIG. 13.These decks will come in a variety of materials plastic composites, or wood This will also give a variety of different strengths and will give way to a variety of colors. I believe that this deck will have a real purpose for those who do not want a permanent deck.

### BACKGROUND OF INVENTION

The Pixie Deck Stow and Go, relates to flooring that anyone can assemble.

### BACKGROUND OF THE INVENTION PRIOR ART

The entire prior art relates to permanent flooring. Tongue and groove for the most part, but some were attached with rails example: #4641469, invented by Wood. This is wood flooring that contains a track strip. The invention #5768850 by inventor Chen, metal joist interlock the wood. None of the inventions had any type of fold up possibilities, or have rollers, nor were any of them portable. Invention #5502939 by inventor Zadok, has material using a foam core, the metal on the joining ends bends and it snaps together. Invention #3859000 by inventor Webster has pieces of wood attached with an L shape attachment. None of these inventions are portable, or have rollers or fold up for storage. Invention #5395341 Kajiwara, has interlocking tongue and groove. The same with invention #6029416 invented by Anderson, again connected by tongue and groove.

I believe I have a unique and needed invention, I know there is a need for this type of decking People don't always want something permanent, but just need something temporary and portable. Also not everyone has the skill to build a deck, or a dock, or flooring for a garage/basement I believe I have solved this problem. I believe that the ramifications of the invention are endless. Since this design is unique from any invention I do believe I have found a solution to this problem.

### OBJECTS AND ADVANTAGES

The object of the Pixie Deck Stow and Go is to be able to have a deck just about where ever you want a deck and you will not need any carpentry skills to do it. The deck that I propose will not need any tools for it to be set up. That is the great thing no tools and you will be able to store this deck away. When you need it, set it up any time and most anywhere. You will be able to make this deck larger just by adding additional sections. You will be able to design the shape of the area desired by using the different size deck sections that you choose to add. Not only will you be able to set this deck up easy, but folding this deck is just as easy. Once the deck has been folded and ready to store the wheels that are built-in will make moving the deck a breeze. If the terrain is not good for wheels, such as going over gravel, the middle beam will double as a Dolly with a skid plate to push the stored deck where ever you want it to go.

The advantage will be a do-it-yourself deck. It will set up quickly and without tools. The deck can be used on the beach. With the use of float devices under the deck, the deck can be anchored in the water and used as a dock. At home the decks can be used in the garden area such as having a garden pathway, or set the deck up in your pets runner to keep your friend high and dry and off the ground. Places in your home such as your garage or basement any where you need things off the ground. It will be an addition to any home, office or business. Having different colors will make it attractive for any décor. This deck will be used inside or out of any home, office or business.

Still further objects and advantages will become apparent from a consideration of the ensuing description and accompanying drawings.

### DRAWING REFERENCE NUMERALS

50 Floor Plank
52 Large Wheel
54 Small Wheel
56 Wheel Rail
58 Axel Rail
60 Side With Rail
62 Side with Rail
64 Side Support
66 Side Support
68 Dowel
70 Dowel Hole
72 Pin
74 Pin Hole
76 Dove connection
78 Small Middle Support Beam
80 Large Middle Support Beam
82 Skid Plate
84 Axel
86 Axel Clip
88 Screw
92 Metal Plate
94 Rail Housing
96 Ties
98 Anchor
100 Floatation Device

### MAIN EMBODIMENT

### Page 1 Shows Floor Plank with Connectors and Wheels

Floor Planks 50, with Dowel 68, Dowel Hole 70, used to attach Floor Planks together to form a deck. Small Wheel 54, allows Floor Plank to roll to one end when deck folds.

### Page 2 Shows a Wheel Rail

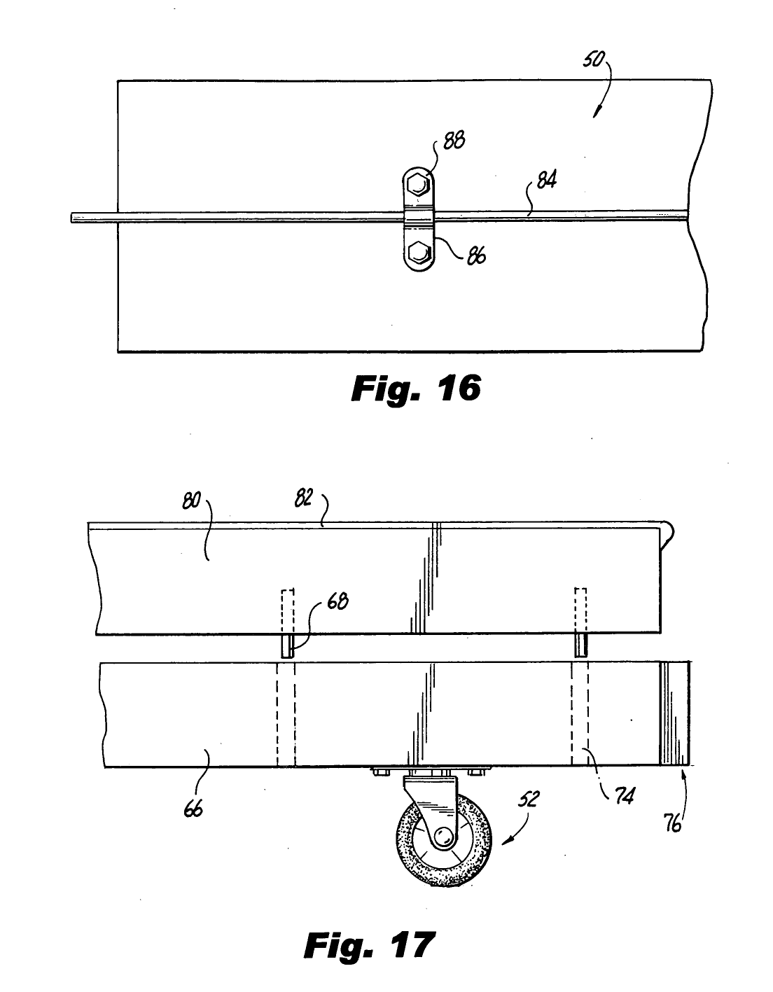

Wheel Rail 56, Axel Rail 58, Wheel 54, The Axel (shown FIG. 16) will glide with Wheel attached.

### Page 3 Shows a Side Railing with a Rail Housing and a Side Support

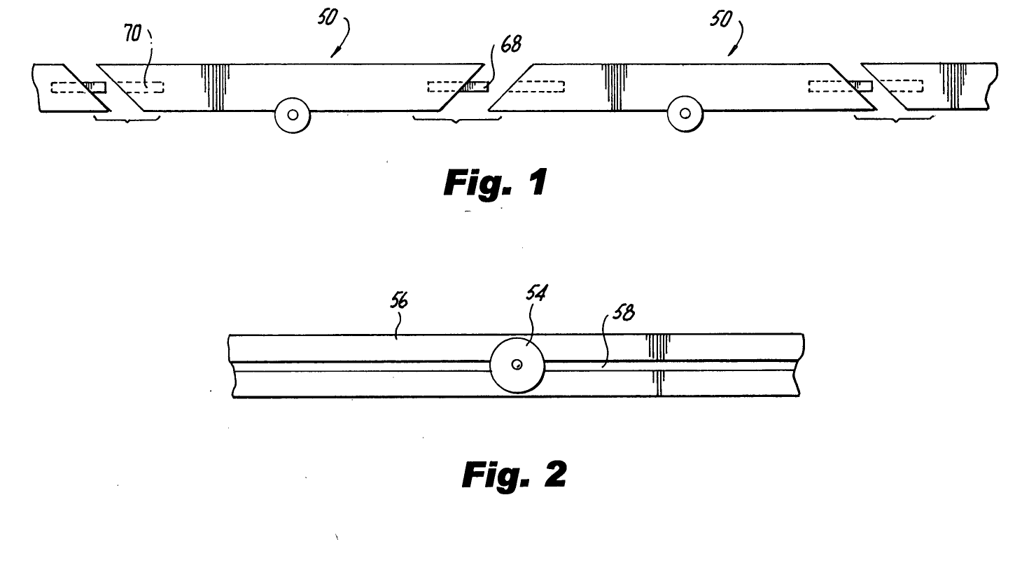

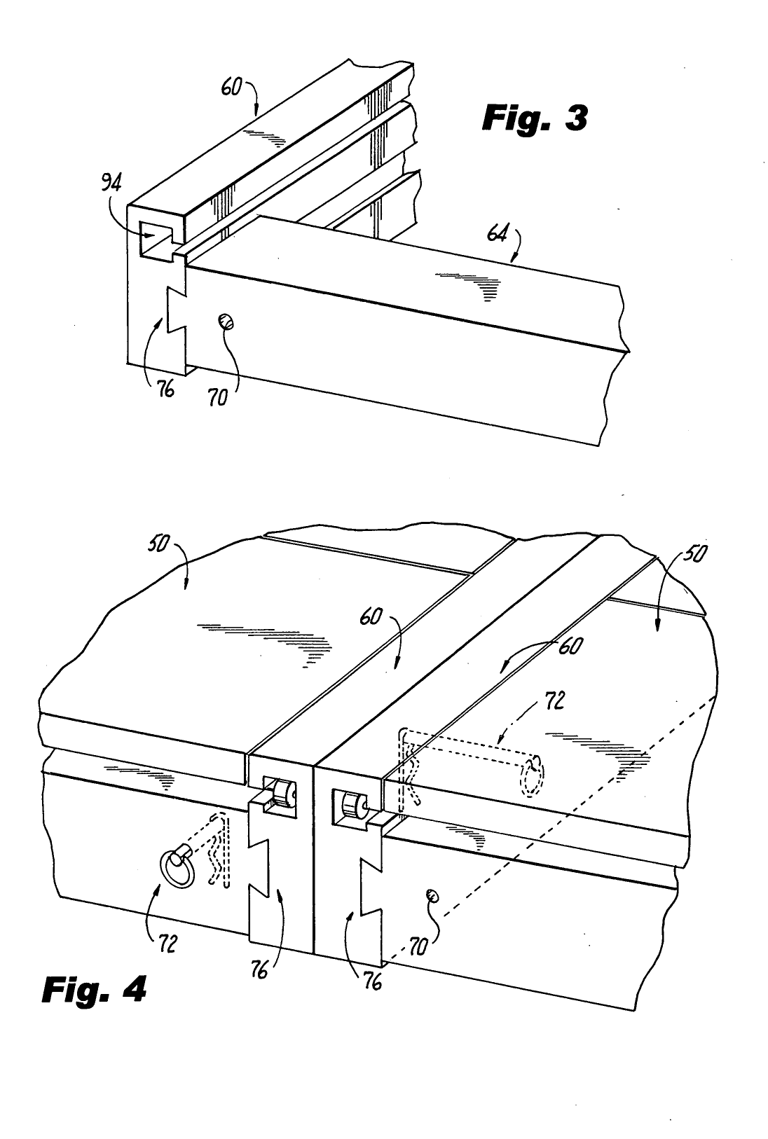

Shows a Side Rail 60, with Rail Housing 94, a Wheel Rail (FIG. 2) will house wheels that will roll along this area. Side Support 64, is attached to side 60, by Dovetail 76, and holds Side Rail secure. The Pin Hole 70, has duel purse, first purpose is for the Pin (shown in FIG. 4) to attach decks together. Second purpose is for Skid Beam (shown FIG. 17) to attach to Side Support 64.

### Main Embodiment

### Page 4 Shows Two Decks Attached

FIG. 4 Shows how decks would be attached be Pins 72.

### Page 5 Shows Small Middle Support Beam

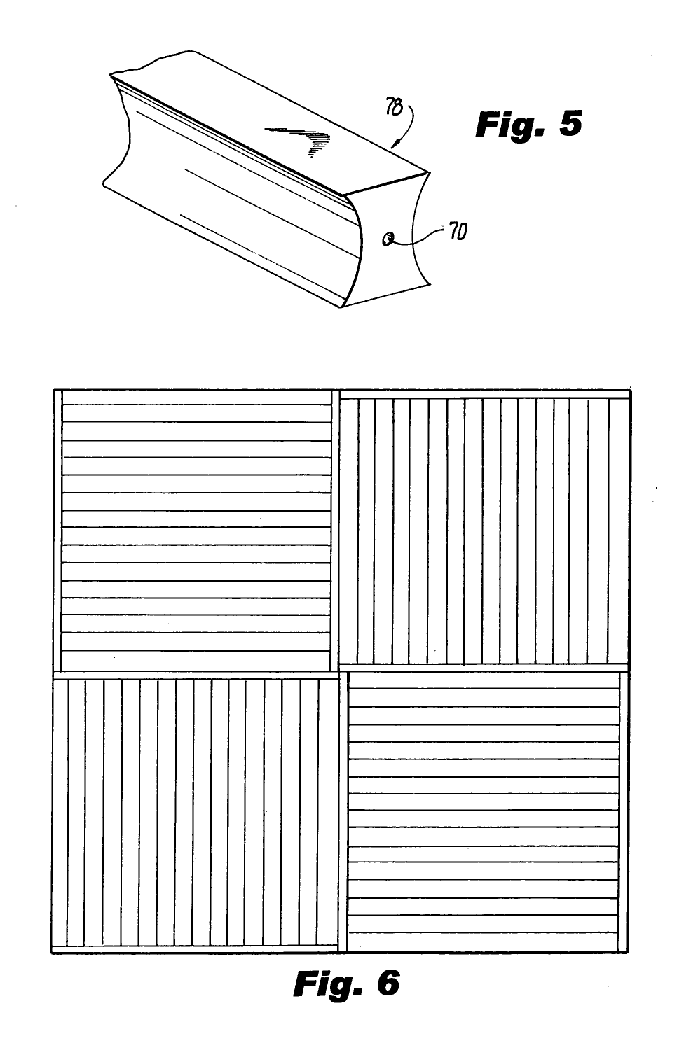

FIG. 5 Shows Small-Middle Beam Support 78, with Dowel Hole 70. Used with smaller decks.

### Page 6 Shows Four Decks Attached

FIG. 6 Example of, but not limited to, four decks attached together.

### Page 7 Shows Floor Planks in Storage Position

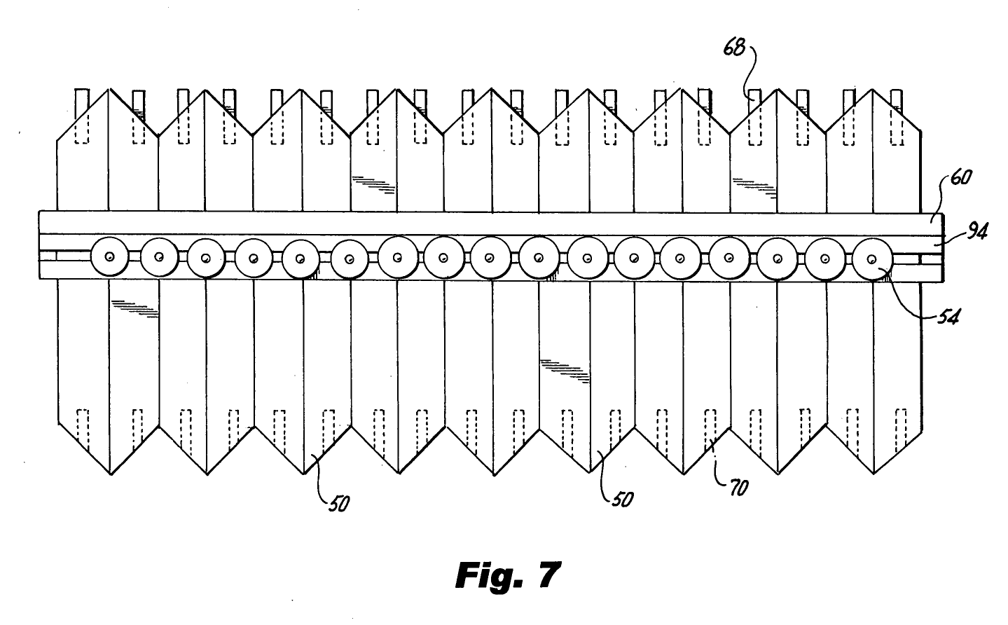

FIG. 7 Shows Floor Planks 50, in a store away position. Wheels 54, rolled back together in Rail Housing 94, that is inside the Side Rail 60. Floor Planks 50, have Dowels 68, on one end and Dowel Hole 70, one the opposite end.

### Main Embodiment

### Page 8 Shows Motion of Floor Planks

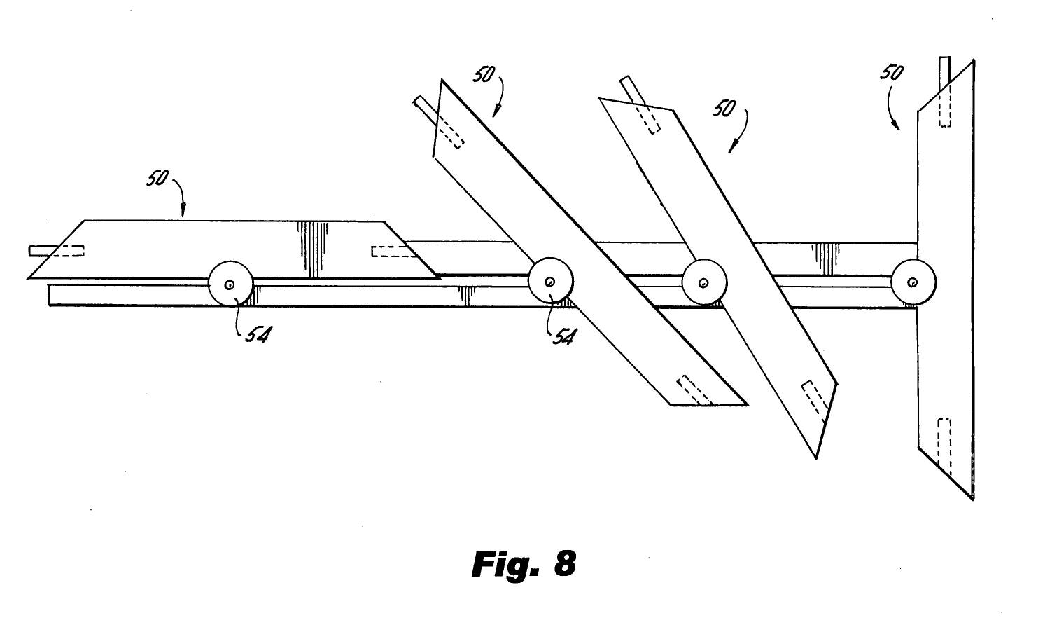

FIG. 8 Action of Floor Planks from store position to open deck position

### Page 9 Shows Deck Folding

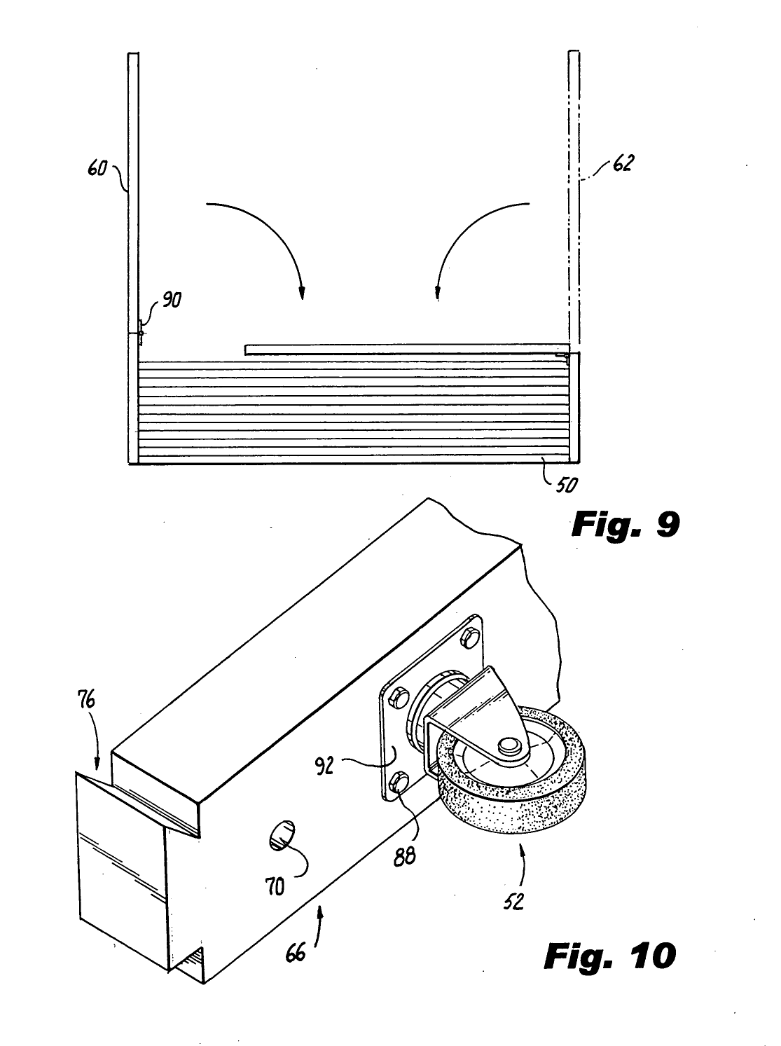

FIG. 9 Shows how a decking will store away. Floor Planks 50 piled. Both Side Rails 60, and 62, have Hinges 90, that fold down. 50.

### Page 10 Shows Support Rail with Wheels

FIG. 10 Shows a Side Support 66, Wheel 52. Wheel attached by Metal Plate 92, with screws 88. Side Support Rail has Dove Connection 76, this attaches to Side with Rail 60. Pin Holes 70 for attaching decks together and attaching Large Middle Beam with Skid Plate (shown in FIG. 17).

### Main Embodiment

### Page 11 Shows Side Support as Dolly

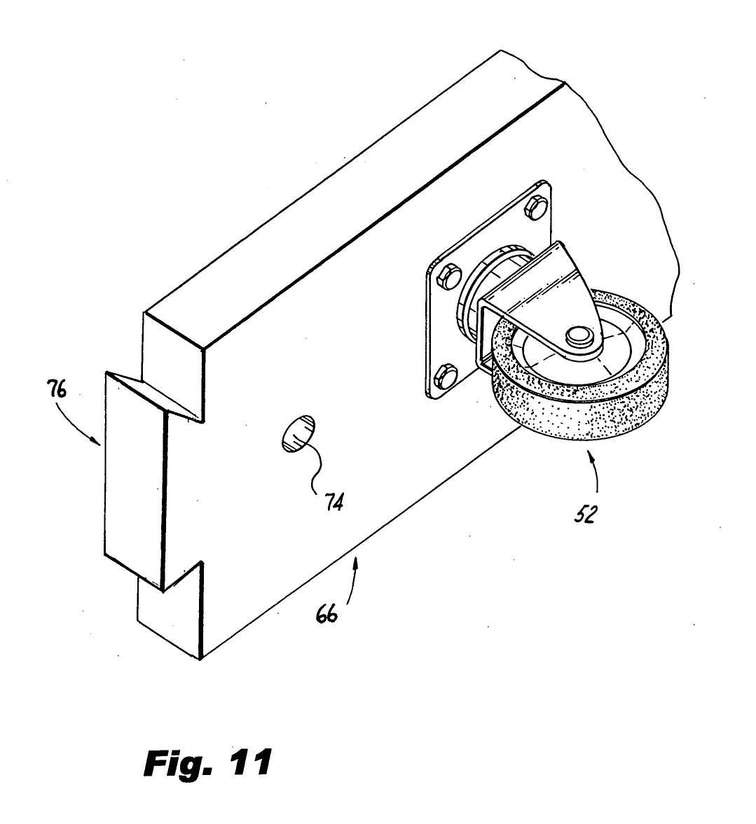

FIG. 11 Shows Side Support 66, when used as dolly Wheel 52 on bottom. Dove connection 68, and Pin Hole 74.

### Page 12 Shows Deck in Water

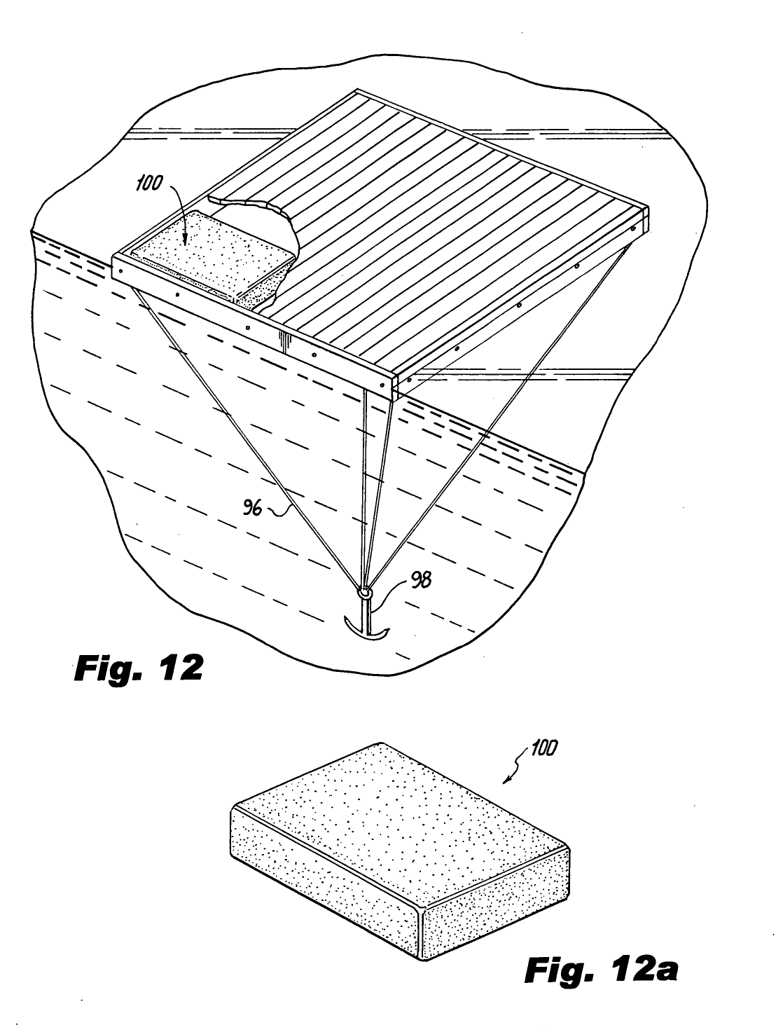

FIG. 12 Deck in water (not limited to size) with ties 96, attached to anchor 98, with a multiplicity of Floatation Devices 100.

### Page 13 Shows Large Middle Support Beam

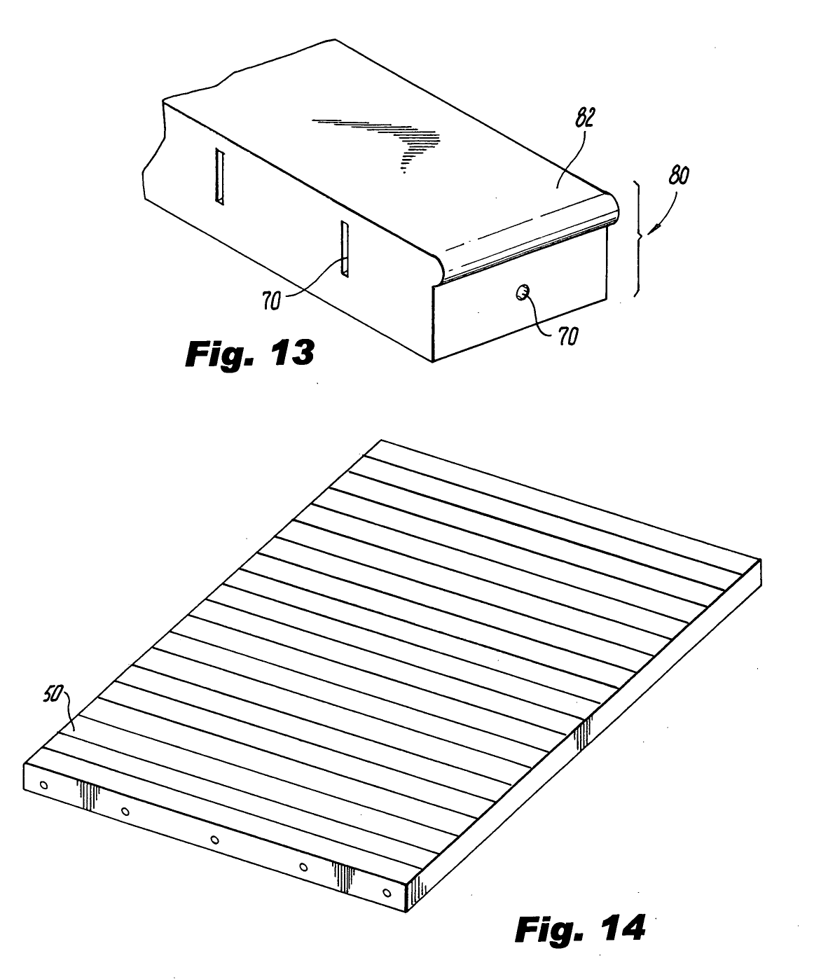

FIG. 13 Large Middle Support Beam 80, with metal skid 82, used when needed For a larger deck in place of a Small Middle Support Beam 78. Large Beam also used when attached to Side Support 66, for easy mobility over different terrain that wheels can not travel. Shows Dowel holes 70, will connect Side Support 66, to Large Middle Support Beam 80.

### Main Embodiment

### Page 14 Shows Deck

FIG. 14 Deck (example but not limited to size.)

### Page 15 Shows Deck being Disassembled

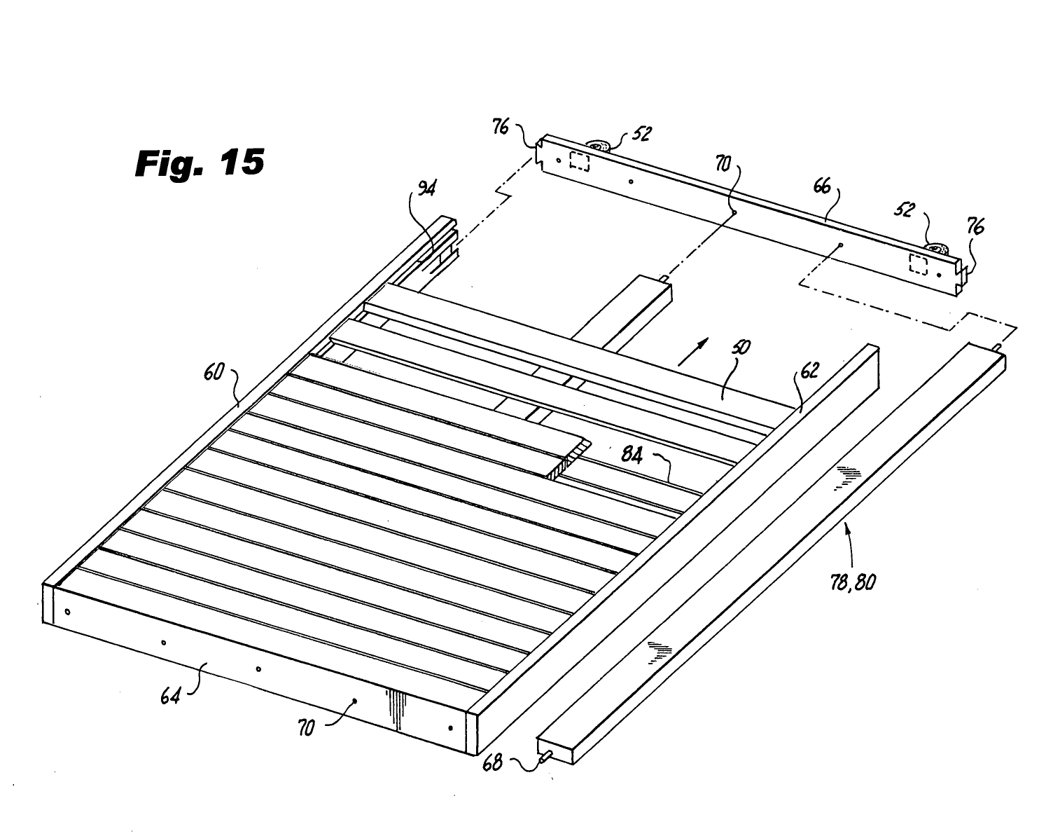

FIG. 15 Side Support 66, with Wheels 52, Dowel Hole 70, and Dove connector 68, disengaged from Side Rails 60 and 62. Side Rail 60 shows Wheel Housing 94. Middle Beam 78 and 80, represent both Large and Small Beam placement. A Dowel 68, at each end of the Middle Beam connects to both Support rails 64, and 66 to Dowel Hole 70. Floor Plank 50 flips on axels 84, attached to Floor Planks 50, in turn are attached to Wheels that run on both Side Rails 60 and 62.

### Page 16 Shows Axel Attached to Floor Plank.

FIG. 16 Shows Axel 84, supported by multiple Axel Clips 86 (one shown) that is attached to the Floor Plank 50, by Screws 88. Axel supports Plank that goes to Wheels in Side Support Rail.

### Main Embodiment

### Page 17 Shows how Large Middle Beam with Skid Attaches to Support Rail

FIG. 17 Show a Large Middle Support 66, with Dowels 68, and Skid Plate 82, attaching to Side Support Rail 66 with Wheel 52 and Dowel Holes 74.

### Conclusions, Ramifications and Scone

Accordingly it can be seen that I have provided a deck that will store away, by A unique folding method and will be transported by the use of its own built in dolly or sliding on the skid plate. You will not have to be a carpenter, and this flooring will be assembled without the use of tools. A portable deck or flooring, an alternative to a stationary deck. When you no longer need it, it simply stores away.

Although the description above contains specificities, these should not be construed as limiting the scope of the invention, but as merely providing illustrations of some of the presently preferred embodiments of this invention. Various other embodiments and ramifications are possible within its scope. For Example: (1.) Wall décor. Using a variety of different materials, and colors I see this as an alternative to paneling. (2.) Flooring, an easy way to cover, insulate that damp basement or garage floor. Special sizes to cover that sump pump Easy to install Flooring to lift that shed off the ground. (3.) Docks for your beach area that anyone can assemble. Decks that keep you off the sand. (4.) I see this as an protection over windows such as hurricane shutters and protection over store windows.

Thus the scope of the invention should be determined by the appended claims and their legal equivalents, rather than by the examples given.

### Summary

The Pixie Deck Stow and Go Deck wilt be self contained. It will store away until needed then you will be able to roll or slide this deck to desired area. This deck will be assembled easily. Where ever you need flooring, decking, or a dock. All this without a hammer, or screw driver.

1. The Pixie Deck Stow and Go will be a self contained, portable decking. The Pixie Deck will contain planks that stack together, made possible by having small wheels on an axle which are attached to the plank and travel on the side rail, this will allow the deck area to become compact, and will allow the side rails to fold When in folded position; the Pixie Deck will be portable, by means of a built in dolly, that uses wheels. When the wheels are not feasible, for example: going over gravel or sand, the built in skid will serve as an alternate means of transport. This deck will be made of different materials, such as wood and/or plastics which will allow for different colors and strengths Different weights for different projects.
